(19) United States
(12) Patent Application Publication
(10) Pub. No.: US 2009/0313219 A1
(43) Pub. Date: Dec. 17, 2009

(54) METHOD FOR ASSOCIATING CONFIGURATION ITEMS TO INCIDENTS

(75) Inventors: Rajeev Gupta, Noido (IN); Hima P. Karanam, New Delhi (IN); Mukesh Kumar Mohania, New Delhi (IN); Maheswaran Surendra, Croton-ou-Hudson, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/138,760

(22) Filed: Jun. 13, 2008

(51) Int. Cl. G06F 7/06; G06F 17/30

(52) U.S. Cl. 707/3; 707/E17.014

(57) ABSTRACT

Techniques for automatically associating at least one configuration item (CI) to an incident are provided. The techniques include parsing an incident, wherein parsing the incident comprises annotating the incident with zero or more annotations and extracting at least one keyword from the incident, and associating each of the zero or more annotations and the at least one keyword with at least one configuration item (CI), wherein associating the zero or more annotations and at least one keyword with at least one CI comprises keyword searching and relationship traversal.

### FIELD OF THE INVENTION

The present invention generally relates to information technology, and, more particularly, to incident management.

### BACKGROUND OF THE INVENTION

A service desk is a single point of contact (SPOC) for users who need help running their information technology (IT) systems. A service desk can be managed by a level-1 (L1) person. Customers contact the service desk for various purposes such as information, configuration change, problem being faced by the customer, etc. Customers can report problems using various methods such as web based, e-mail or telephone. The L1 person tries to satisfy the customer requests as much as possible to facilitate the restoration of normal operational service with minimal enterprise impact on the customer. Usually, a database of historic incidents and their corresponding resolutions are maintained at the service desk. The L1 person can use a keyword search to see if the service request can be resolved using any of the previously reported incidents.

If the incident cannot be resolved, an artifact of the incoming request is created in the form of an incident ticket which initiates the chain of various IT system management (ITSM) processes such as incident management, problem management, configuration management, change management and release management. Directly or indirectly, all of these processes start with the incident management process. The incident management process provides the most immediate and visible gains to service quality and cost reduction. The problem management process can be used to find the root cause of incident(s) so that similar incidents can be avoided in the future. To alleviate the root cause, one or more of change, configuration and release management processes can be involved.

As part of the incident management process, an incident ticket can be created and the ticket, along with relevant information, can be forwarded to a level-2 (L2) person who is a subject matter expert (SME) for the incident. The SME tries to resolve the incident through his or her expertise.

This process of incident resolution is largely manual. Thus, it is time consuming and error prone. In existing approaches, service personnel need to identify software or hardware components responsible for incident. As noted above, L1 and/or L2 personnel do this job by manually correlating information on incident ticket with the infrastructure information. Keywords are identified and possible failing components are identified manually. Further, existing approaches do not include techniques for automatically identifying configuration items (CIs) and assets related to an incident description.

### SUMMARY OF THE INVENTION

Principles of the present invention provide techniques for associating configuration items (CIs) to incidents. An exemplary method (which may be computer-implemented) for automatically associating at least one configuration item to an incident, according to one aspect of the invention, can include steps of parsing an incident, wherein parsing the incident comprises annotating the incident with zero or more annotations and extracting at least one keyword from the incident, and associating each of the zero or more annotations and the at least one keyword with at least one configuration item, wherein associating the zero or more annotations and at least one keyword with at least one CI comprises keyword searching and relationship traversal.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a typical incident management workflow, according to an embodiment of the present invention;

FIG. 2 is a diagram illustrating typical enterprise architecture, according to an embodiment of the present invention;

FIG. 3 is a diagram illustrating an exemplary configuration management database (CMBD) data model, according to an embodiment of the present invention;

FIG. 4 is a diagram illustrating a sample search template, according to an embodiment of the present invention;

FIG. 5 is a diagram illustrating system architecture, according to an embodiment of the present invention;

FIG. 6 is a diagram illustrating asset association approaches, according to an embodiment of the present invention;

FIG. 7 is a diagram illustrating example features for various classes of incidents, according to an embodiment of the present invention;

FIG. 8 is a diagram illustrating example mapping between incident class and asset class, according to an embodiment of the present invention;

FIG. 9 is a diagram illustrating incident management, according to an embodiment of the present invention;

FIG. 10 is a diagram illustrating a sample service desk ticket, according to an embodiment of the present invention;

FIG. 11 is a diagram illustrating a configuration management database (CMBD) data model, according to an embodiment of the present invention;

FIG. 12 is a diagram illustrating configuration item (CI) discovery, according to an embodiment of the present invention;

FIG. 13 is a diagram illustrating automated classification of service requests, according to an embodiment of the present invention;

FIG. 14 is a diagram illustrating a classification based approach to asset association, according to an embodiment of the present invention;

FIG. 15 is a flow diagram illustrating techniques for automatically associating at least one configuration item (CI) to an incident, according to an embodiment of the present invention;

FIG. 16 is a diagram illustrating a typical extensible markup language (XML) representation for a template, according to an embodiment of the present invention; and

FIG. 17 is a system diagram of an exemplary computer system on which at least one embodiment of the present invention can be implemented.

### DETAILED DESCRIPTION OF PREFERRED EMBODIMENT

Principles of the present invention include associating service desk incidents with assets and configuration items. One or more embodiments of the invention include automatically associating configuration items (CIs) and assets with incident records so that efficient incident resolution and impact assessment can be achieved. Principles of the invention also include improving the incident management process so that it can be performed in an automated manner, thus reducing the incident processing time.

An incident ticket contains information about the customer and problem reported by him or her. Problem related information may include, for example, a system which is facing the problem, the severity of the problem, natural language description of the problem, etc. One or more embodiments of the present invention use both structured and unstructured information to help in identifying client asset and possible failing components (for example, CI).

As described herein, one or more embodiments of the invention include identifying CIs related to an incident. The techniques described herein include extracting keywords from the incident description, and performing an object based search in a configuration database using the extracted keywords. Additionally, one or more embodiments of the invention include identifying an asset related to an incident so as to know the source of the incident and resolve it. Such techniques can include building a model from a set of incident description along with their incident and/or asset classes. The model can be used to automatically assign an incident and/or asset class to new incident descriptions. A mapping is defined between the incident classification and an asset classification. Based on the model and the mapping, an asset class is automatically identified corresponding to an incident description.

Further, the techniques described herein include automated association of configuration item (CI) to an incident in a service desk, automated association of assets with client incident in a service desk and using associated CIs and assets for automatically routing the incident to a technical expert. Also, one or more embodiments of the invention include performing CI-incident association by automatically identifying keywords and searching in CMDB objects and relationships. Additionally, incident-CI and asset association can be used for automated routing of incidents.

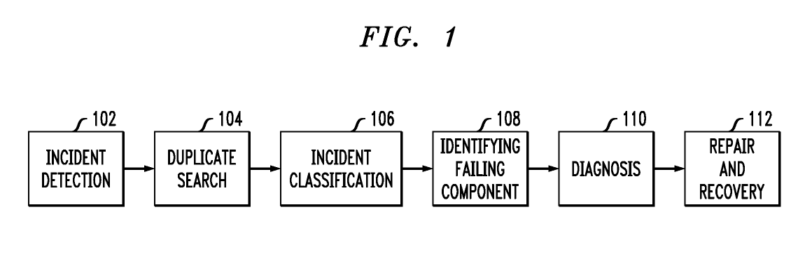

One aim of the incident management process is quickly resolving incidents that affect the normal running of an organization's IT services. An incident is an intimation of some error or failure of some component in IT systems. FIG. 1 is a diagram illustrating an incident management workflow, according to an embodiment of the present invention. By way of illustration, FIG. 1 depicts incident detection in step 102, duplicate search in step 104, incident classification in step 106, identifying a failing component in step 108, diagnosis in step 110 and repair and recovery in step 112.

FIG. 1 illustrates an incident management workflow that can be used for resolving an incident. In a typical service desk, an incident is either reported by the customer or automatically generated by a monitoring and/or event generation system. A customer can report incidents by describing the system condition using natural language text. Similarly, incidents generated automatically by systems may also have natural language text. For such incidents, a level-1 (L1) person does a quick keyword based search from a database of historic incidents. If any matching incident is found, its solution may be used to resolve the incoming incident.

If the L1 person cannot provide a resolution, an incident record is created. This incident record is classified for various purposes such as, for example, assigning priority based on urgency and impact, selecting the appropriate SME, etc. A failing component can be identified by manually associating hardware or software components (configuration items) responsible for the incident. Information about these configuration items (CIs) is maintained in a configuration management database (CMDB) which can also be used by other IT service management (ITSM) processes as an underlying data storage framework. An L1 person can, for example, use keyword searching along with human intelligence to estimate the possibly responsible CIs. Then, the incident ticket is forwarded to L2 support to diagnose the problem in the selected CI.

For diagnosis, the CI is monitored and various probes may be used. If the identified CI is wrong, the ticket is bounced back and forth between L1 and L2 support. If any code change is required, external support (for example, L3) is contacted. After resolving the problem, the customer is informed and incident ticket is closed.

As described herein, one or more embodiments of the invention automatically associate client assets and failing CI with the incident ticket. IT asset management can be used for managing finances, contracts and usage of IT assets throughout their lifecycles so that enterprise requirements are met with balanced cost, predictability and regulatory compliance. Asset management involves management of inventory, software licenses, procurement, leases, cost accounting, retirement and disposal. In contrast, CIs can be used to provide a logical model of the IT infrastructure in the organization that can be accessed by various IT processes including incident management process.

As described herein, associating a CI with the incident ticket helps in identifying failing components and prioritizing incident resolution. Associating client asset with the incident ticket helps in resolving incidents quickly, eliminating a series of manual question-answering between the technician (L1 person) and the client. The incident root cause analysis and resolution can begin with the exact make, model, and configuration of a desktop, printer or application that is creating the incident. An associated asset can also be used as an attribute to route the ticket to the most appropriate technician.

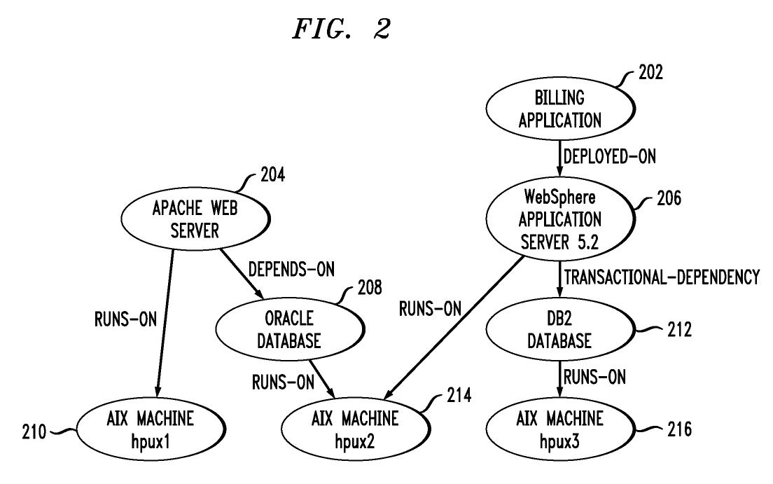

Effectiveness of the incident management process depends on the speed and the accuracy of the process to identify the failing component. That, in turn, is closely aligned to the accuracy and design of the configuration management database (CMDB). CMDB stores configuration items which represent systems, software and people in enterprise infrastructure. FIG. 2 is a diagram illustrating enterprise architecture, according to an embodiment of the present invention. By way of illustration, FIG. 2 depicts the elements of a billing application 202, an apache web server 204, a websphere application server 206, an oracle database 208, and an aix machine (hpux1) 210. FIG. 2 also depicts the elements of a DB2 database 212, an aix machine (hpux2) 214 and an aix machine (hpux3) 216.

FIG. 2 illustrates a typical enterprise infrastructure represented using configuration items and relationships between them. The nodes shown in FIG. 2 are CIs stored in CMDB and edges between them are explicit relationships between CIs. Relationships are also stored in CMDB as objects. For example, Oracle database can be stored as an object with its attributes such as, for example, schema, tablespace, etc. Similarly, an Aix machine hpux2 can also be stored with its attributes such as, for example, central processing unit (CPU) type, memory, etc. Another relationship object can be created, for example, with type runs-on whose source-attribute is the oracle database object and target-attribute is hpux2. Each edge shows depth=1 relationships. To find the database on which billing application is running, one needs to traverse depth=2.

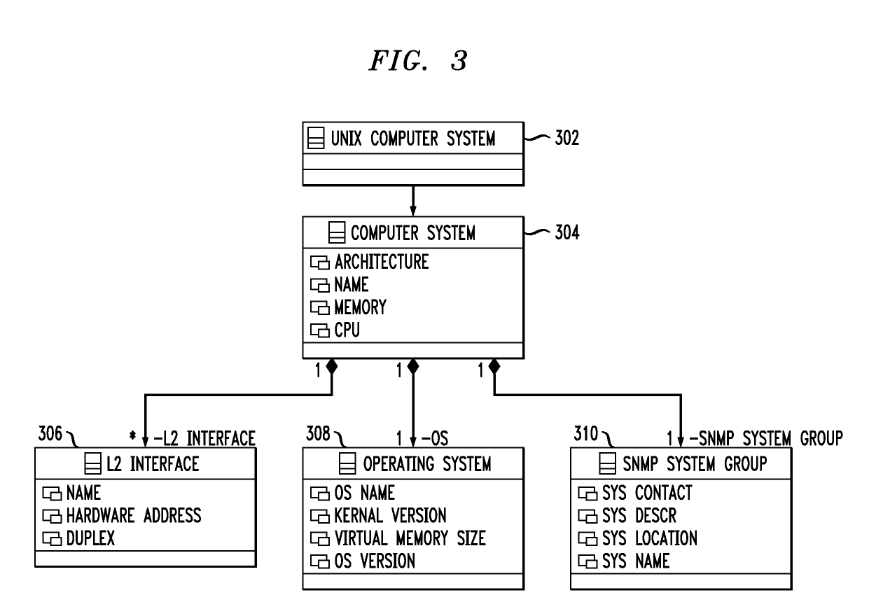

CMDB have another kind of relationship of implicit types. These implicit relationships are part of the CMDB data model. FIG. 3 is a diagram illustrating an exemplary configuration management database (CMBD) data model, according to an embodiment of the present invention. By way of illustration, FIG. 3 depicts the elements of a unix computer system 302, a computer system 304, an L2 interface 306, an operating system 308 and a simple network management protocol (SNMP) system group 310.

FIG. 3 illustrates an example of an implicit relationship where a Unix computer is sub-category of computer and operating system is a child of that. These explicit and implicit relationships can be used to know the details of all the linux machines in the enterprise such as, for example, which machines they are installed-on, what software is running on them, etc. When an L1 person searches the CMDB, she mainly considers CIs either without bothering about relationships or considers them in an ad-hoc manner. In one or more embodiments of the invention, CMDB is searched using keywords extracted from the incident description. All CIs having attribute values matching with those keywords are returned as keyword search results. If the L1 person is not satisfied by the results, he or she searches again and/or explores CIs related to returned CIs in a very adhoc manner. This process is largely manual heavily dependent on skills of L1 persons making it unreliable and costly. As such, for a given incident, it is advantageous to search CMDB, considering both CIs and relationships, so that failing component can be identified with more accuracy and minimal human intervention.

A typical incident record contains three types of information: customer details such as name, contact information, e-mail address, etc., ticket information including status of the ticket, severity, system and/or component related to the ticket, etc., and problem description giving client's perception of the problem. For identifying relevant keywords, problem description can be used. Customer and other ticket related information can be used for determining scope of the search in CMDB. For example, customer related information can be used to search only a particular part of CMDB belonging to that customer. Simple rule engines can be created to process the structured customer and ticket information, but processing a natural language description of the problem using simple rules is not possible. An L1 person needs to understand the problem to decide on the keywords to be used to search CMDB. An L1 person expects that these keywords will result in the possible failing component for the given incident ticket.

As described herein, one or more embodiments of the invention include automatically extracting relevant keywords from incident description. Incident tickets are usually managed using web-based interface. Thus, one step of the incident processing is to extract the incident description using a hypertext transfer protocol (HTTP) parser or from the database where the tickets are stored. As information entered in the incident description may be unclean, one needs to clean that unstructured data. For example, one can use edit distance between keywords and dictionary words to clean the incident description. As one needs to search for keywords in CI types (for example, an oracle database) and attribute values (for example, hpux3.ibm.com) of CIs, in an incident description (in English language) only nouns or noun phrases need to be extracted.

Also, another step in identifying keywords is to normalize the extracted nouns. For example, a computer name may be mentioned in its short form (hpux3 for hpux3.in.ibm.com), thus, if required, one can identify such machine names and normalize them by appending their domain names. Similarly, it is possible that all the attributes use internet protocol (IP) addresses whereas an incident description has a uniform resource locator (URL). Thus, one needs to replace them with commonly agreed format. To further improve the search performance, one can annotate noun-phrases using named-entity (NE) annotators that annotate keywords based on their types.

By associating CI-types with these keyword annotations, one can limit the search scope further. For example, if a particular keyword is identified as a software-name, it need not be searched in CIs of type ComputerSystem. A dictionary matcher can be used to categorize keywords to classes such as hardware and software using a dictionary of names. Similarly, it can be used to identify a software type such as “WebSphere application server” as a single keyword.

All the keywords extracted can be used to search the CMDB. But this search is not likely to be efficient due to following considerations. Typical CMDB implementations are not done with a keyword search in mind. Instead, CMDB is mainly used for browsing from one object to its parent and/or child or other related objects. Also, CMDB is largely implemented as object oriented database. The concept of a keyword search over object oriented database is not well-defined. Various questions such as, for example, which attribute(s) to search, how to search child objects, is it possible to index objects, etc. need to be answered to efficiently search an object oriented database.

Additionally, while doing a keyword search, relationships are not taken into account. Keyword searching and relationship browsing should advantageously be integrated. When a customer describes a problem, it is his or her perception of the problem that may not include much information about the actual failing component. Instead, it is likely to have some information about neighboring and/or dependent objects. For efficiently and automatically locating failing components, one can use indexing and object navigation as described herein.

For making a CMDB search efficient, one can index all of the CMDB objects. Indexing CMDB objects can enable one to search not only with keywords but also with relationships. For example, one can efficiently search all the computer-systems that have Linux Enterprise Edition v3.1 as an operating system. Further, one can also search for relationships which are arbitrarily deep. These issues can be resolved by creating two indices (that is, a keyword index and a relationship index) over CMDB, as described herein.

The aim of the keyword index is to identify objects having a given keyword in the values of its attributes. This index maps each keyword with a set of objects. The keyword index can have, for example, four columns: keyword, object-id, object-desc and object-class. The object-desc (object description) column is used to display name of objects so that service personnel can identify and get details of any of the displayed objects. The object-class column is used to indicate type of the object (for example, computer system, database, security certificate, etc.). To synchronize the index with the modifications in the underlying CMDB, one can poll the CMDB logs periodically to get updates since last poll. All of the newly added, deleted and/or updated objects are reflected in the index.

A relationship index is created to efficiently search and/or browse over related objects. One can use these relationships to extract context of the incident search automatically. For example, if an incident describes two machines that are not able to communicate, then a possible failing component may be the CI corresponding to a network-link between them. As with the keyword index, for creating the relationship index, all configuration items are obtained one-by-one and all its depth=1 relationships are stored in the relationship index.

For getting objects related with higher depths, multiple invocations on the relationship index can be done. Each relationship can be defined by its source object, target object and relationship type between them. Table 1 below depicts example entries for the relationship index. In the relationship index, oid-1 is the object-id of the object we are parsing, oid-2 is the object-id of the related object, relationship-type gives name of the implicit and/or explicit relationship and direction is forward (backward) if a parsed CI is the source (target) CI of the relationship. Both explicit as well as implicit (parent-child) relationships are covered using the relationship index.

TABLE 1
Example relationship index

| | | relationship- | |
|---|---|---|---|
| oid-1 | oid-2 | type | direction |
| ab4569000 | ph9067230 | Installed On | forward |
| ph9067230 | ab4569000 | Installed On | backward |
| ab4569000 | dc4587689 | parent-child | forward |
| dc4587689 | ab4569000 | parent-child | backward |

Keyword searching may result in lots of objects. One does not want to overburden the service desk personnel by showing lots of results. Further, search context is captured by the objects represented by keywords as well as their neighborhood objects, and one naive approach is to get all of the neighborhood objects of objects returned by an ordinary keyword search. Such an approach is also likely to return lots of unnecessary objects that the service desk personnel will have to examine. In general, all of the CMDB objects can be related to each other, and therefore one needs a way of limiting the number of results of the search.

Search results can be limited in multiple ways. For example, keyword search results can be returned with their corresponding TF-IDF scores. In this case, objects with top-k relevance scores are shown to the service desk personnel, who can select the failing component from the list shown. Also, in this case, a list of objects is shown so that ratio of scores between a bottom ranking object and that of a top ranking object is above a certain threshold. Such an approach is motivated by the fact that if a bottom rank object has a very low relevance score, then it is better not to show that to service desk personnel.

As described herein, one can combine the above criterions to output minimum results to the service desk personnel. Configurable parameter nₘₐₓ can be used to indicate the maximum number of results to be returned (top-k). Another parameter γ can be used to indicate the lower bound on the ratio of score of the bottom ranked object and the top-ranked object. Also, let the results returned by the CMDB search have relevancy scores {c₁, c₂, . . . cₙ} in descending order. Thus,

$$n < {n}_{max} and \frac{{c}_{n}}{{c}_{1}} > γ \qquad ( 1 )$$

An actual number of objects returned by the keyword search will be given by the more restrictive of conditions given by Equation (1). As detailed herein, search context is obtained by neighborhood objects of objects directly mentioned in the incident description using keywords. Additionally, as described below, one can obtain search context via a number of mechanisms where CMDB relationships are used.

As such, one or more embodiments of the present invention include an omni-directional search. If there is no other information, then one can simply consider getting neighbors of all of the objects resulted from an ordinary keyword search. This forms a base-line scheme. As one object may be related, directly or indirectly, to a large number of objects, one may not opt to access all of the related objects. The object navigation can be limited up to a certain relationship-depth (rd). For example, rd=1 signifies that only directly related objects will be used for getting incident context. By keeping rd=2, we get objects that are directly related to the related objects (for example, database to billing application in FIG. 2), etc.

The relevancy score of neighborhood objects depends on the score of the keyword search results to which they are related, type of relationship and depth. Equation (2) is used to get the relevancy score of a related CI (RCI) that is related to one keyword search CI (KSCI).

$$RR = r \times {\prod }_{0 \leq i \leq r d} \frac{{w}_{i} ( rel\_type )}{α} \qquad ( 2 )$$

RR is the relevancy score of the related CI (RCI), r is the relevancy score of the KSCI to which it is related, w(rel_type) is the weight assigned to the type of relationship, and rd is the relationship-depth between the KSCI and its related RCI. The value of w(rel_type) lies between 0 and 1, depending on the type of relationship. One can give more weight to a parent-child implicit relationship compared to explicit relationships. Further, among explicit relationships, larger weight can be given to a relationship type if any problem in their target may lead to problem in source.

Configuration parameter α(>1) makes sure that the RR value of the RCI is less than the relevancy (TF-IDF) score of its related KSCI. If an RCI is related to more than one KSCI, then its relevancy score is a sum of all its individual RR values. By way of example, one or more embodiments of the invention are only interested in neighboring objects having score more than cₙ (otherwise, it will not be part of results shown to the service personnel). As one object may be related to more than one object, one can calculate scores of all related objects having RR values more than cₙ/β; where β(>1) is a configuration parameter. Thus, an RCI can be part of a result only if:

$$RR = {c}_{i} \times {\prod }_{0 \leq i \leq d} \frac{{w}_{i} ( rel\_type )}{α} > \frac{{c}_{n}}{β} \qquad ( 3 )$$

This provides the bounds on the relationship weight and depth to which relationships can be explored. These bounds reduce the navigation scope drastically, thus improving search performance. As w(rel_type)≦1 and cᵢ≦cₗ, from Equation (3):

c₁/α^{d}>cₙ/β (4)

Thus, from Equations (1) and (4) we get,

$$d < \frac{log ( β / γ )}{log ( α )} \qquad ( 5 )$$

Similarly, we can obtain the minimum weight of the relationship to be explored using,

w(rel_type)>α×γ/β (6)

Equations (5) and (6) can be used reduce the search scope without any adverse impact on quality of results presented to the service personnel. Typical values of various parameters discussed herein are given in Table 2 below.

TABLE 2
Typical parameter values.

| Parameter-name | Value |
|---|---|
| nmax | 20 |
| α | 3 |
| β | 3 |
| γ | 0.05 |

One or more embodiments of the present invention also include a super object search. This is useful when service desk personnel can guess the type of object which may be responsible for the incoming incident. In such a case, all child objects are considered as part of its parent object. For example, if one wants to find the machine (Computer System) responsible for the incident, then one can search for keyword in a super object containing a Computer System object along with all its children such as Operating System, File System, etc. This ensures that the entire physical object is considered a single logical object, leading to better results.

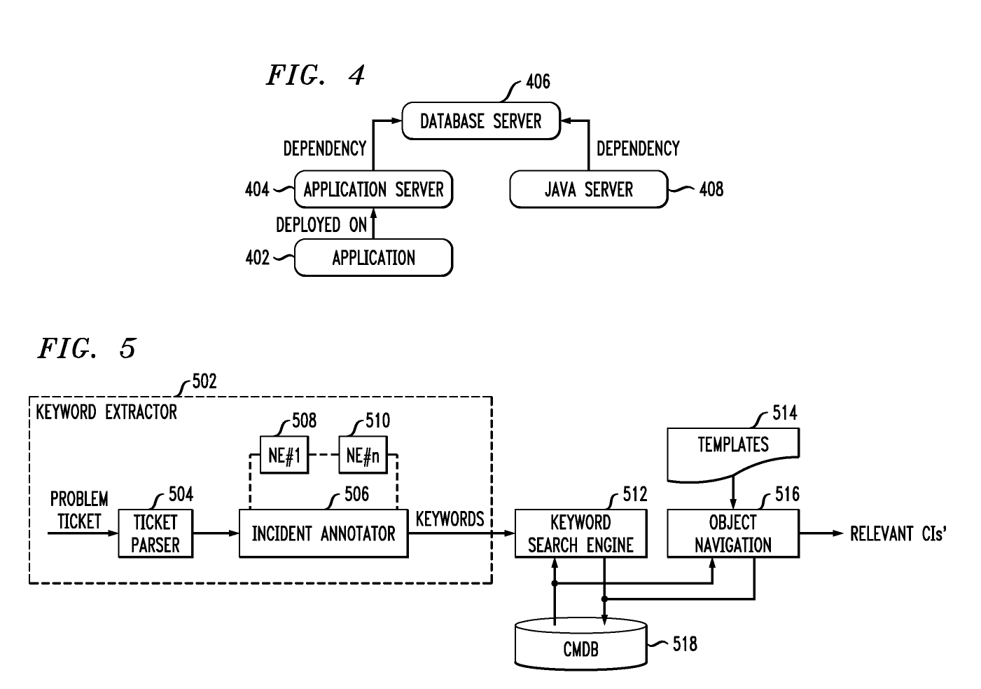

Further, one or more embodiments of the present invention include a directed search. In such a case, one wants to include both implicit as well as explicit relationships in a manner that is more intelligent than the omni-directional search. One can perform a directed search by using what is referred to herein as search templates. This scheme is useful when service desk personnel can identify the type of object responsible for the incident along with relationships that can be useful in getting the search context. In general, a search template can be represented as tree of CIs and relationships as shown in FIG. 4. FIG. 4 is a diagram illustrating a sample search template, according to an embodiment of the present invention. By way of illustration, FIG. 4 depicts the elements of an application 402, an application server 404, a database server 406 and a java server 408.

Search templates are a subset of a data model including CMDB object types with implicit and explicit relationships between them. A directed search has multiple distinctive features. For example, a keyword search using this template will involve CMDB objects of types database server, application server, Java server and application. All resultant objects of child type are traversed using relationships specified on edges to get their corresponding target objects. Thus, all the resultant objects of type “Application” are traversed using the “Deployed on” relationship to get their corresponding “Application Server” objects. These objects are further traversed using a “Dependency” relationship to get the corresponding “Database Server” objects.

Service desk personnel are presented with objects of the root type, that is, “Database Server”. The relevancy score of each object can be calculated in the manner similar the approached described herein. Thus, a “Database Server” object, which is parent of lots of resultant child objects (result of keyword search), will have a higher score.

For both super-object searching and directed searching, one can selectively use relationships to get the search context. For super-object searching, only implicit relationships are considered whereas for directed searching, both implicit as well as explicit relationships can be used. In both cases, it is advantageous to choose the correct search template and/or super object. A search template can be selected with various object types as root. Service desk personnel can select the appropriate template by guessing the object type that is most likely to be responsible for the incident.

One or more embodiments of the present invention can be implemented, for example, as per the architecture shown in FIG. 5. FIG. 5 is a diagram illustrating system architecture, according to an embodiment of the present invention. By way of illustration, FIG. 5 depicts the elements of a keyword extractor 502, which includes a ticket parser 504, an incident annotator 506, NE #1 508 and NE #n 510. FIG. 5 also depicts a keyword search engine 512, templates 514, object navigation 516 and a CMBD 518.

A keyword extractor component can be implemented for identifying keywords and annotating them. One can use a part-of-speech (POS) tagger to identify noun-phrases from the given incident description. Also, one can use a regular expression matcher to identify certain kinds of attributes such as internet protocol (IP) addresses and uniform resource locators (URLs), whereas synonym matcher can be used to add domain names with ambiguously specified machine names. By way of example only, IBM's unstructured information management framework (UIMA) can be used to annotate keywords based on their object types such as, for example, <hardware>, <software>, etc.

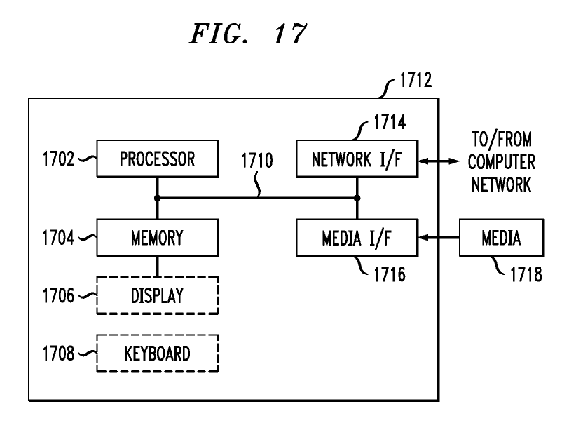

To implement keyword and relationship indices, one can, for example, extend the openly available Lucene framework of document indexing. An object can have attributes of various types such as integer, float, char, string etc., besides other objects. From a keyword search point of view, only strings (or character arrays) are important, as all of the keywords are usually stored as strings. Further, one can assume that all of the object attributes can be accessed using public methods (for example, get*( ) methods in Java). Results of all such methods can be combined, using space separated concatenation, to create a text document corresponding to an object. These documents can be fed to Lucene to create the keyword index. A relationship index can be created by browsing all relationships of depth 1. The keyword index and the relationship index can also be placed on the server machine itself, which makes the index synchronization task easier. Object navigation templates can be represented in extensible markup language (XML) format for super-object searching as well as directed browsing. FIG. 16 is a diagram illustrating a typical extensible markup language (XML) representation 1602 for a template, according to an embodiment of the present invention.

As described herein, assets can be used in an asset management system to manage cost, contracts and ownership throughout their lifecycles. Thus, a data model used to store assets is very different from what is used for CIs. A CI data model has many sophisticated relationships so that CMDB can be used for changing risk assessment, impact assessment, root cause analysis of problems, etc. Such relationships are not required for assets. They have implicit relationships such as, for example, parent-child between assets, and ownership relationships between an asset and its owner. Further, attributes maintained for assets are very different from CI attributes. As noted herein, different types of CIs have different attributes, but all assets have the same set of attributes such as purchase information, owner-id, location, site, classification-id, etc. Thus, an approach described for CI association will not work for asset association.

One or more embodiments of the invention include automatically associating assets with client incidents. Assets are usually organized in hierarchical classes. With each asset, a class is associated therewith. For example, all laptops in an enterprise can be classified under a hardware and/or notebook category. One can use an incident classification based approach for asset association and/or a text classification technique for asset association.

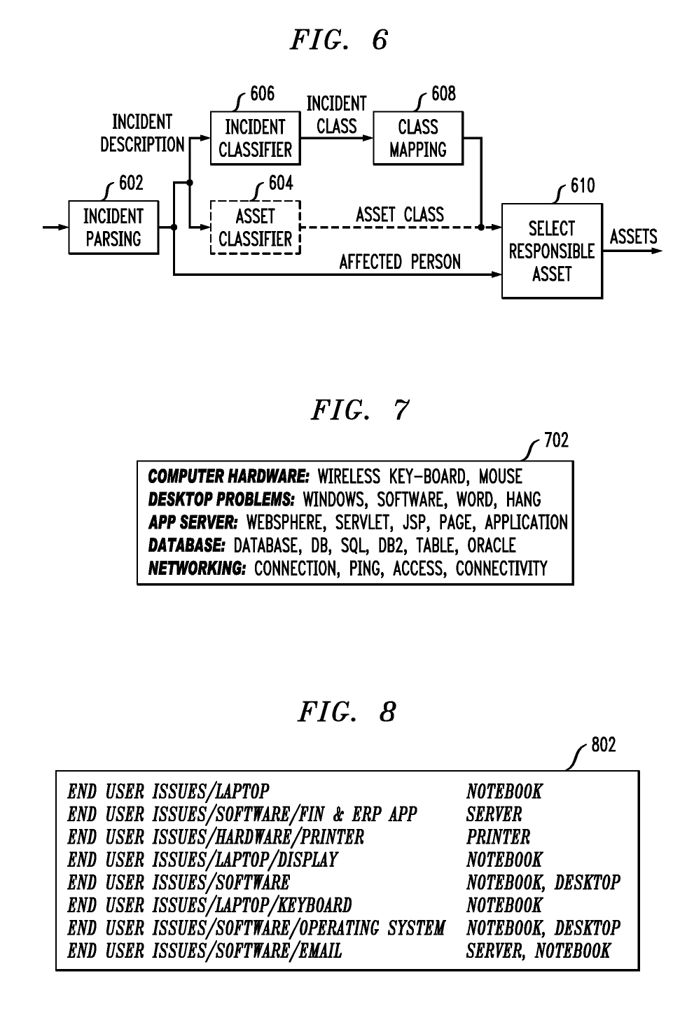

Also, there are alternate ways to get to the client asset class. For example, one can use text classification to get an asset class (AC) and use the asset owned by the client, who reported the incident or is affected by the incident to select the client asset belonging to the asset class. Such an approach is illustrated in FIG. 6 where an incident description is fed to the dashed branch between the asset classifier 604 and the component selecting a responsible asset 610. FIG. 6 is a diagram illustrating asset association approaches, according to an embodiment of the present invention. By way of illustration, FIG. 6 depicts the elements of incident parsing 602, an asset classifier 604, an incident classifier 606, class mapping component 608 and selecting a responsible asset 610.

Additionally, one can use text classification to get an incident class (IC), and use a mapping between incident classes and asset classes to get the asset class (AC). Also, one can use the asset owned by the client who reported the incident or is affected by the incident to select the client asset belonging to the AC class. This approach is also illustrated in FIG. 6 where the incident description is fed to the branch between the incident classifier 606, the class mapping component 608 and the component selecting a responsible asset 610.

When a client reports an incident, an asset is associated with the incident to determine the source of the incident. Asset association helps in pin-pointing the problem and resolving the incident. Also, an associated asset is one of the assets that the effected person owns (uses) (for example, “Wireless is not working”: Laptop; “Word is crashing repeatedly”: MS office, etc.). In one or more approaches described above, incident description is classified to either incident classes or asset classes. One can, for example, use a text classification technique for both getting the incident and asset class for a given incident description.

As described herein, text classification can be used in associating assets with the incoming incident. For text classification, one trains a classifier using a historic set of incident descriptions and their corresponding classes. These classes should be asset classes for the first above-noted approach and incident classes for the second above-noted approach. As such, a set of representative features (words) can be obtained for each of the classes.

FIG. 7 is a diagram illustrating example features 702 for various classes of incidents, according to an embodiment of the present invention. FIG. 7 shows examples of various incident classes and typical words used to describe incidents of a particular class. For a new incident, these representative features can be used to get the corresponding asset or incident class. For example, if an incident description uses words like connection, access, ping, etc. to describe the problem, the problem is classified as a “Networking” problem. One can use a support vector machine technique to get the class for the given incident description. Both incident and asset classes can also be hierarchical. In those cases, multiple invocations of the text classification can be used to get the corresponding class at each level of the hierarchy.

As described herein, a technique for asset association can include extracting incident description, selecting keywords, getting assets that the affected person owns, and keyword searching over probable assets using its relationships. As depicted in FIG. 6, an additional step of class mapping is required if the incident text is first classified to the incident class. Such a step may be required in cases where classification accuracy, during test phase, is more for the classification to incident classes. One can configure the system by providing a mapping between incident classes to asset classes. Such a mapping can be many-to-many. FIG. 8 shows one such example mapping. FIG. 8 is a diagram illustrating example mapping between incident class and asset class 802, according to an embodiment of the present invention.

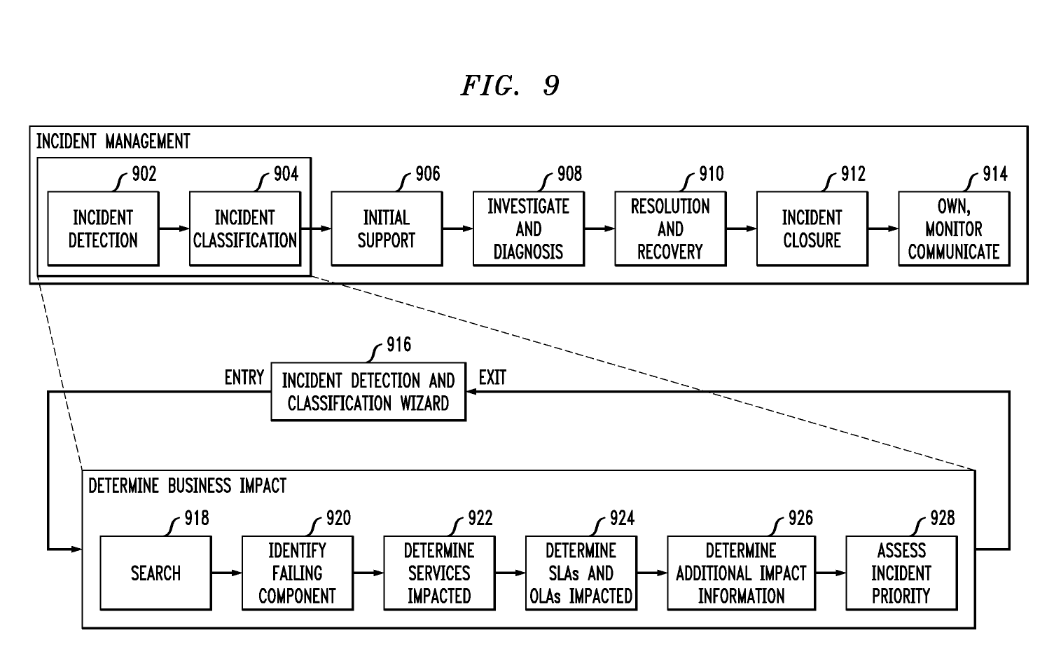

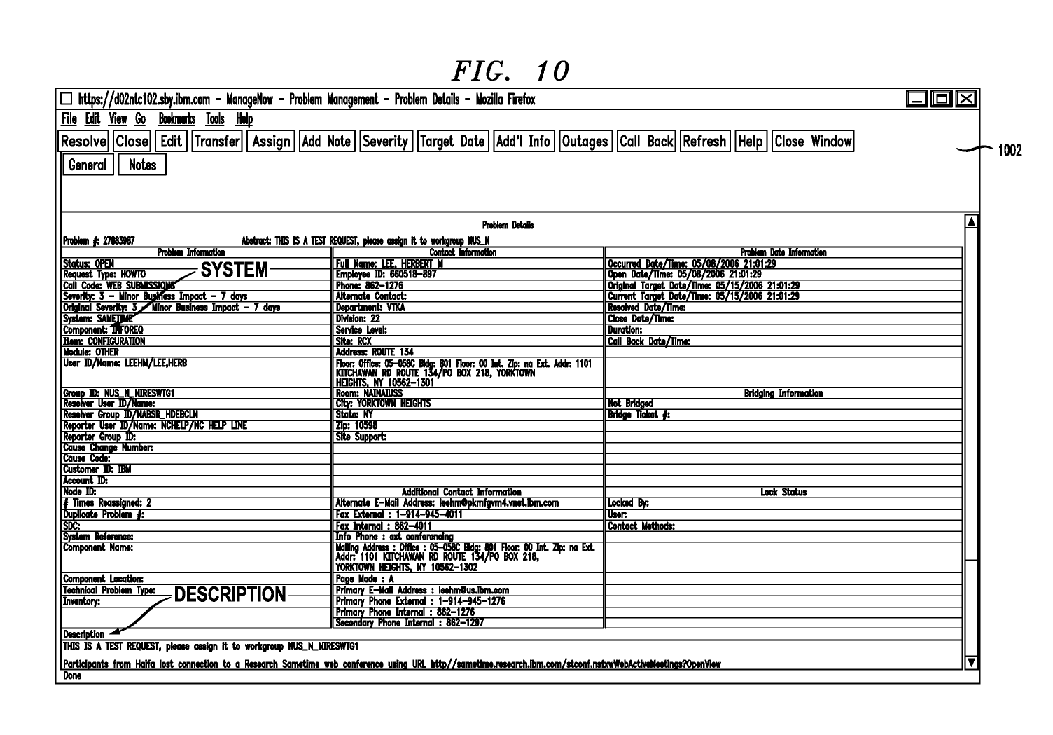

FIG. 9 is a diagram illustrating incident management, according to an embodiment of the present invention. By way of illustration, FIG. 9 depicts incident detection in step 902, incident classification in step 904, providing initial support in step 906, investigation and diagnosis in step 908, resolution and recovery in step 910, incident closure in step 912 and owner and monitor communication in step 914. FIG. 9 also depicts incident detection and classification wizard 916, searching in step 918, identifying a failing component in step 920, determining services impacted in step 922, determining service level agreements (SLAs) and operating level agreements (OLAs) impacted in step 924, determining additional impact information in step 926 and assessing incident priority in step 928.

FIG. 10 is a diagram illustrating a typical service desk ticket 1002, according to an embodiment of the present invention. By way of illustration, FIG. 10 depicts a manage-now ticket application. One objective of incident management is the resolution of incidents that affect the normal running of an organization's IT services. An incident management workflow can include incident classification, identifying failing component and incident resolution among other components. Incidents are managed by a service desk application (for example, e-ESM-ManageNow). ManageNow incident tickets can include a title, description, classification info, severity and many other attributes of the incident.

Also, one or more embodiments of the invention include enhancing the value of the incident management by automatically correlating an incident with relevant configuration-items stored in a configuration management database (CMDB) and assets stored in asset database. Mean time to restore service is reduced, and requests can be prioritized by associating enterprise value with CIs and assets. Requests can also be routed automatically to a suitable subject matter expert.

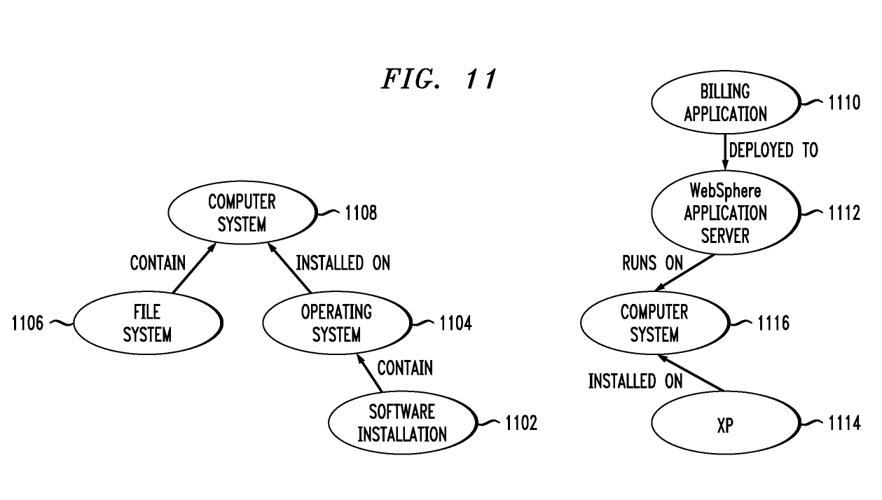

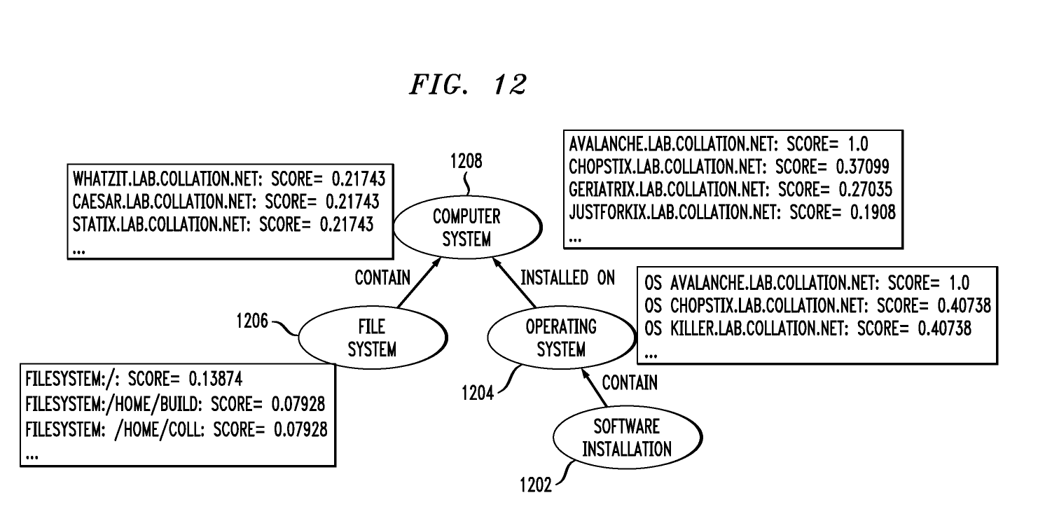

As noted above, one or more embodiments of the present invention include a CMDB. FIG. 11 is a diagram illustrating a configuration management database (CMBD) data model, according to an embodiment of the present invention. By way of illustration, FIG. 11 depicts the elements of software installation 1102, an operating system 1104, a file system 1106 and a computer system 1108. FIG. 11 also depicts a billing application 1110, a websphere application server 1112, XP 1114 and a computer system 1116.

Such a database can include, for example, a repository of information about machines, hardware, software, people, etc. in an enterprise, and relationships between them. These objects can be referred to as configuration items (CIs) having an object class, attribute name-value pairs, sub-objects, etc. Relationships between CIs can be forward as well as backward (for example, installedOn, runsOn, etc.). By way of example, a Tivoli CMDB can be accessed using Java application programming interfaces (APIs) to perform various tasks such as adding and deleting CIs, searching for CIs belonging to a particular type (for example, WebSphere servers), browsing through relationships, etc. CMDB has SQL-like language to search (for example, to get the names of all computer-systems having more than two CPUs). Discovery mechanisms exist to populate CMDBs automatically.

Configuration items can be stored in CMDBs. Configuration items are modeled for change and configuration management being used by various ITSM processes such as problem management, change management, availability management, etc. Assets can be stored in an asset database for life-cycle management. An asset database is used for asset management, and an asset database can be integrated with CMDB.

By way of example, an exemplary incident annotation can include the following.

Incident Description: Not able connect to sun webserver on linux from
10.10.10.171.
Annotated String: Not able connect to sun webserver on linux
from <IPAddress> 10.10.10.171 <IPAddress>.
Object based search: in Lucene engine using annotated (and un-annotated)
keywords for the object types specified in the template.

Object types for such an exemplary incident annotation can include, for example, ComputerSystem, FileSystem, OperatingSystem, and SoftwareInstallation. Keywords can include, for example, Sun, WebServer, Linux, <IPAddress>, 10.10.10.171, and <IPAddress>. Keywords, used for searching CMBD, can be filtered intelligently using annotations and object types such as, for example, the following.

ComputerSystem: Sun, Linux, 10.10.10.171; and

FileSystem: Sun, Linux.

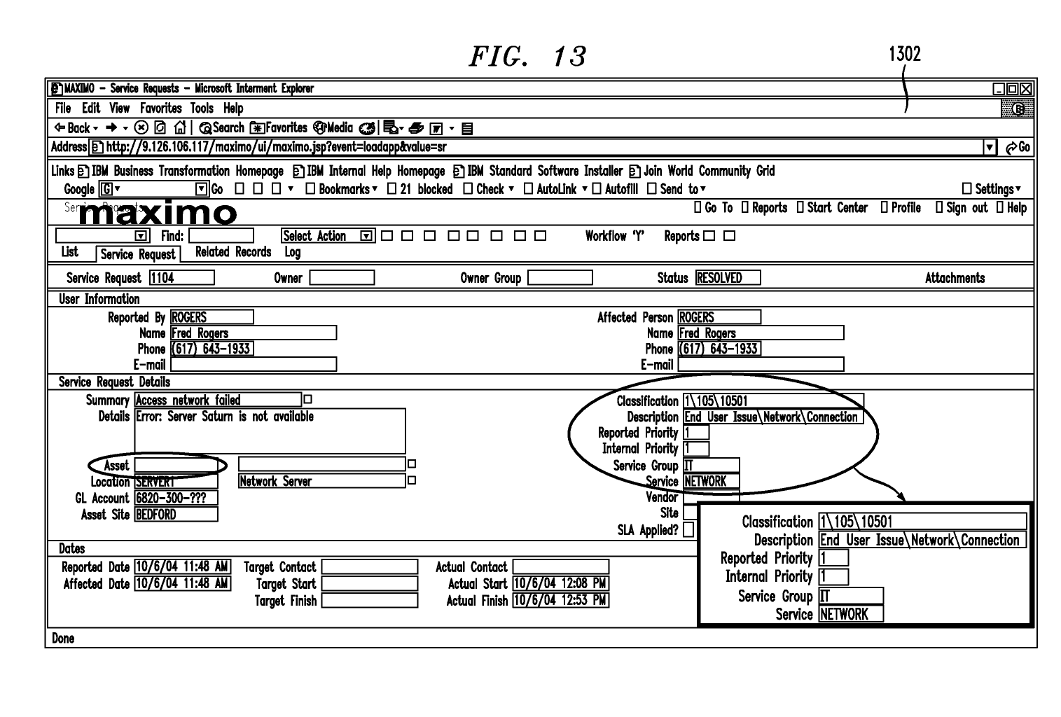

As described herein, one or more embodiments of the invention include discovering CIs using templates (including objects and object relationships). FIG. 12 is a diagram illustrating configuration item (CI) discovery, according to an embodiment of the present invention. By way of illustration, FIG. 12 depicts the elements of software installation 1202, an operating system 1204, a file system 1206 and a computer system 1208. Results of child (node) objects are browsed using (edge) relationships to get objects of a parent class.

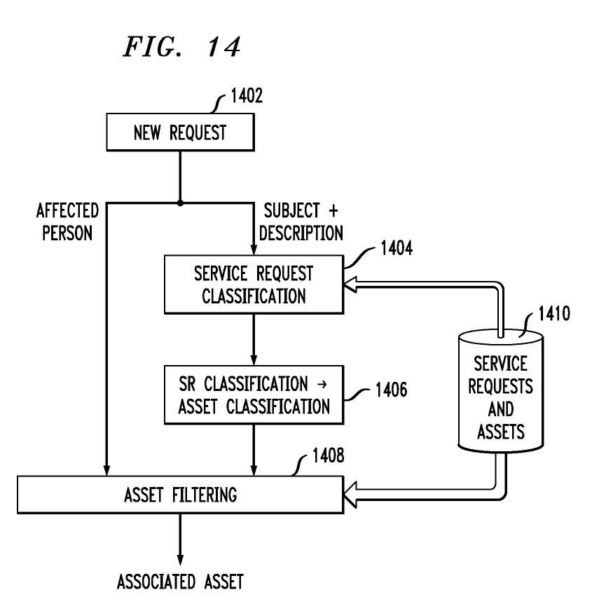

FIG. 13 is a diagram illustrating automated classification of service requests 1302, according to an embodiment of the present invention. Additionally, FIG. 14 is a diagram illustrating a classification based approach to asset association, according to an embodiment of the present invention. By way of illustration, FIG. 14 depicts receiving a new request in step 1402, service request (SR) classification in step 1404, asset classification in step 1406, asset filtering in step 1408 and service requests and assets 1410.

As illustrated in FIG. 14, offline steps can include getting service requests with their service request classification information, building a model to learn the classification using the service request description, and defining mapping between service request classification and asset classification. Online steps can include, for example, for an incoming request, getting the list of probable assets using an “affected person id,” getting the asset class using the classification model, and selecting the asset belonging to the above asset class among the probable assets.

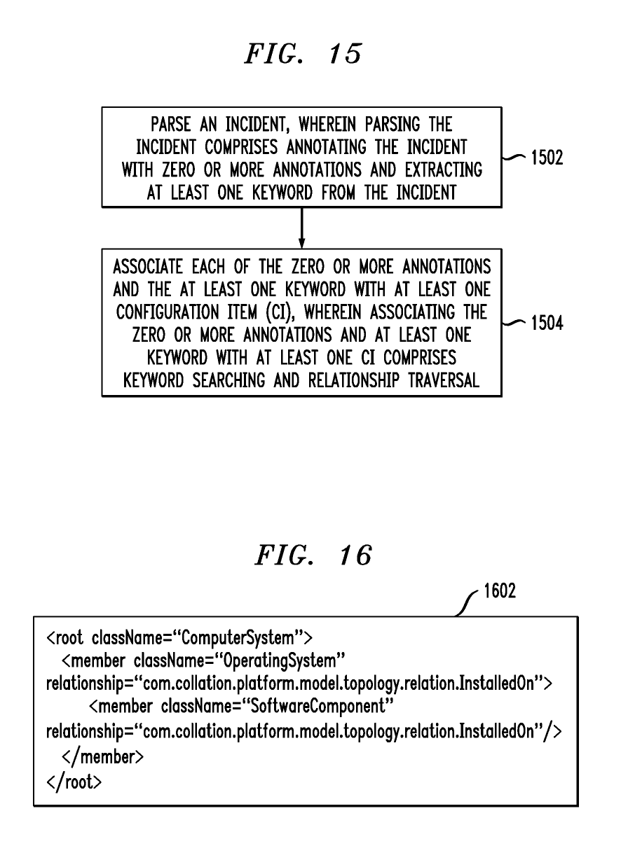

FIG. 15 is a flow diagram illustrating techniques for automatically associating at least one configuration item (CI) to an incident, according to an embodiment of the present invention. Step 1502 includes parsing an incident, wherein parsing the incident comprises annotating the incident with zero or more annotations and extracting at least one keyword from the incident. Step 1504 includes associating each of the zero or more annotations and the keywords with at least one CI, (for example, a CI described in a data model of an information technology (IT) environment) wherein associating the annotations and keywords with at least one CI includes keyword searching and relationship traversal.

The traversal of a relationship graph (representing data model of the IT environment) can be done with or without the help of search templates. Search templates can include, for example, configuration item types and relationships among them.

The at least one CI can include at least one artifact that is described in a data schema and/or model of an information technology (IT) environment, and wherein the at least one artifact can include, for example, assets, IT components (such as, for example, servers, storage, network, software applications, enterprise processes and their sub-components) and relationships between the IT components. The incident can include a ticket in a help desk system, wherein the incident ticket can be, for example, submitted by a user and/or support personnel, and/or generated by an event monitoring system.

Additionally, the incident ticket can include a textual description of the incident, and related information including, for example, user identity, timestamp and/or priority. Also, the incident ticket may or may not explicitly identify some or all of the implicated or causing CIs in the incident.

The techniques depicted in FIG. 15 can also include associating the annotations (for example, if available) and keywords with at least one CI using one or more classifiers. Associating the annotations and keywords with a CI using classifiers can include using the classifiers to leverage an ontology, using an incident description of the ticket is to build an incident classifier, using the incident classifier to classify the incident into an incident class, using custom-added rules to obtain an asset class from each incident class, and using the asset class and structured information (for example, the person reporting the incident) from the ticket to associate an asset with the incident.

Also, one or more embodiments of the invention include using at least one identified CI, at least one asset and at least one class to build a rule based engine, wherein the rule based engine automatically routes the incident to an appropriate service desk personnel and/or a subject matter expert.

As noted above, FIG. 16 is a diagram illustrating a typical extensible markup language (XML) representation 1602 for a template, according to an embodiment of the present invention.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 17, such an implementation might employ, for example, a processor 1702, a memory 1704, and an input and/or output interface formed, for example, by a display 1706 and a keyboard 1708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 1702, memory 1704, and input and/or output interface such as display 1706 and keyboard 1708 can be interconnected, for example, via bus 1710 as part of a data processing unit 1712. Suitable interconnections, for example via bus 1710, can also be provided to a network interface 1714, such as a network card, which can be provided to interface with a computer network, and to a media interface 1716, such as a diskette or CD-ROM drive, which can be provided to interface with media 1718.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 1718) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 1704), magnetic tape, a removable computer diskette (for example, media 1718), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 1702 coupled directly or indirectly to memory elements 1704 through a system bus 1710. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 1708, displays 1706, pointing devices, and the like) can be coupled to the system either directly (such as via bus 1710) or through intervening I/O controllers (omitted for clarity).

Network adapters such as network interface 1714 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, automatically associating configuration items (CIs) and assets with incident records.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for automatically associating at least one configuration item (CI) to an incident, comprising the steps of:
parsing an incident, wherein parsing the incident comprises annotating the incident with zero or more annotations and extracting at least one keyword from the incident; and
associating each of the zero or more annotations and the at least one keyword with at least one configuration item (CI), wherein associating the at least one annotation and at least one keyword with at least one CI comprises keyword searching and relationship traversal.

2. The method of claim 1, wherein the at least one CI comprises at least one artifact that is described in at least one of a data schema and model of an information technology (IT) environment, and wherein the at least one artifact comprises at least one of one or more assets, one or more IT components and one or more relationships between the one or more IT components.

3. The method of claim 1, wherein the incident comprises a ticket in a help desk system.

4. The method of claim 3, wherein the incident ticket is at least one of submitted by at least one of a user and support personnel, and generated by an event monitoring system.

5. The method of claim 3, wherein the incident ticket comprises a textual description of the incident, and related information comprising at least one of user identity, timestamp and priority.

6. The method of claim 1, further comprising associating each of the zero or more annotations and the at least one keyword with at least one CI using one or more classifiers.

7. The method of claim 6, wherein associating each of the zero or more annotations and the at least one keyword with at least one CI using one or more classifiers comprises the steps of:
using the one or more classifiers to leverage an ontology;
using an incident description of the ticket is to build an incident classifier;
using the incident classifier to classify the incident into an incident class;
using one or more custom-added rules to obtain an asset class from each incident class; and
using the asset class and structured information from the ticket to associate an asset with the incident.

8. The method of claim 1, further comprising using at least one identified CI, at least one asset and at least one class to build a rule based engine, wherein the rule based engine automatically routes the incident to at least one of an appropriate service desk personnel and a subject matter expert.

9. A computer program product comprising a computer readable medium having computer readable program code for automatically associating at least one configuration item (CI) to an incident, said computer program product including:
computer readable program code for parsing an incident, wherein parsing the incident comprises annotating the incident with zero or more annotations and extracting at least one keyword from the incident; and
computer readable program code for associating each of the zero or more annotations and the at least one keyword with at least one configuration item (CI), wherein associating the zero or more annotations and at least one keyword with at least one CI comprises keyword searching and relationship traversal.

10. The computer program product of claim 9, wherein the at least one CI comprises at least one artifact that is described in at least one of a data schema and model of an information technology (IT) environment, and wherein the at least one artifact comprises at least one of one or more assets, one or more IT components and one or more relationships between the one or more IT components.

11. The computer program product of claim 9, wherein the incident comprises a ticket in a help desk system.

12. The computer program product of claim 11, wherein the incident ticket is at least one of submitted by at least one of a user and support personnel, and generated by an event monitoring system.

13. The computer program product of claim 11, wherein the incident ticket comprises a textual description of the incident, and related information comprising at least one of user identity, timestamp and priority.

14. The computer program product of claim 9, further comprising computer readable program code for associating each of the zero or more annotations and the at least one keyword with at least one CI using one or more classifiers.

15. An apparatus for automatically associating at least one configuration item (CI) to an incident, comprising:
a memory; and
at least one processor coupled to said memory and operative to:
parse an incident, wherein parsing the incident comprises annotating the incident with zero or more annotations and extracting at least one keyword from the incident; and
associate each of the zero or more annotations and the at least one keyword with at least one configuration item (CI), wherein associating the zero or more annotations and at least one keyword with at least one CI comprises keyword searching and relationship traversal.

16. The apparatus of claim 15, wherein the at least one CI comprises at least one artifact that is described in at least one of a data schema and model of an information technology (IT) environment, and wherein the at least one artifact comprises at least one of one or more assets, one or more IT components and one or more relationships between the one or more IT components.

17. The apparatus of claim 15, wherein the incident comprises a ticket in a help desk system.

18. The apparatus of claim 17, wherein the incident ticket is at least one of submitted by at least one of a user and support personnel, and generated by an event monitoring system.

19. The apparatus of claim 17, wherein the incident ticket comprises a textual description of the incident, and related information comprising at least one of user identity, timestamp and priority.

20. The apparatus of claim 15, wherein the at least one processor coupled to said memory is further operative to associate each of the zero or more annotations and the at least one keyword with at least one CI using one or more classifiers.
